(19) United States
(12) Patent Application Publication
(10) Pub. No.: US 2026/0119120 A1
(43) Pub. Date: Apr. 30, 2026

(54) Audio Spatial Notifications

(71) Applicant: Dell Products L.P., Round Rock, TX (US)

(72) Inventors: Walter Kemp, Georgetown, TX (US); David Allen Dyson, Pflugerville, TX (US); Suraj M Varma, Portland, OR (US)

(73) Assignee: Dell Products L.P., Round Rock, TX (US)

(21) Appl. No.: 18/932,565

(22) Filed: Oct. 30, 2024

(51) Int. Cl. G06F 3/16

(52) U.S. Cl. CPC G06F 3/167; G06F 3/165

(57) ABSTRACT

This invention relates to an information handling system that enables audio output routing based on screen regions. The system comprises a display controller and an audio output controller, allowing users to associate specific audio playback devices with defined regions on a display. By determining the position of application windows, the system dynamically routes audio content to the appropriate playback device as the window moves between regions. This innovation supports seamless switching of audio outputs, enhancing user experience in environments requiring multiple audio configurations, such as audio mastering or multimedia applications.

### BACKGROUND

Desktop and laptop computers generate sounds through a combination of hardware and software components, enabling them to play sounds produced by applications. Applications such as music players, video games, or system notifications generate sound signals, which are typically in the form of digital audio data. This data is represented as a series of numbers that encode sound waves. The computer's operating system manages the applications' requests to play sounds, usually through an audio driver. The digital audio data is processed by the computer's sound card or other audio interface. This card converts the digital signals into analog signals that can be played by speakers or headphones. Many modem motherboards have integrated sound cards, while some high-performance systems use dedicated sound cards for better audio quality. At the core of the sound card is a Digital-to-Analog Converter (DAC) that transforms the digital signal (ones and zeros) into an analog signal (a continuous waveform). This process is necessary because speakers and headphones require analog signals to produce sound. The analog signal generated by the DAC is then sent to external or built-in speakers or headphones, where it vibrates a diaphragm to create sound waves. These sound waves are interpreted by the human ear as music, voice, or other audio.

### SUMMARY

According to one aspect of the present invention, an Information Handling System (IHS) for providing audio spatial notifications comprises at least one processor configured to execute an operating system (OS) and one or more applications. The OS comprises a display controller configured to manage display content presented across multiple monitors, wherein the display content is generated from the one or more applications, and an audio output controller configured to manage audio content provided to one or more audio playback devices. The OS is configured to determine a screen location of a first application window displayed on one or more of the multiple monitors, wherein the first application window contains display content associated with a first application, and automatically apply panning to audio content associated with the first application based upon the screen location of the first application window.

According to another aspect, the IHS comprises an OS further configured to determine a primary monitor associated with the first application window based upon the screen location and apply the panning so that the audio associated with the first application is played by an audio playback device associated with the primary monitor. According to yet another aspect, the screen location of the first application window is determined based upon a center point of the first application window. According to another aspect, the screen location of the first application window is determined based upon an origin point of the first application window. According to yet another aspect, the screen location of the first application window is determined based upon an edge of the first application window. According to another aspect, the primary monitor is determined based upon which of the multiple monitors is displaying the highest percentage of the display content associated with the first application.

According to yet another aspect, the panning comprises horizontal panning that creates an audible indication of a horizontal location of the first application window across the multiple monitors. According to another aspect, the horizontal panning comprises playing audio content associated with the first application on an audio playback device associated with a primary monitor displaying the first application window. According to yet another aspect, the horizontal panning comprises applying stereo panning to audio content sent to the audio playback devices from the first application. According to another aspect, the panning comprises vertical panning that creates an audible indication of a vertical location of the first application window across the multiple monitors.

According to yet another aspect, an Information Handling System (IHS) for providing audio spatial notifications comprises at least one processor configured to execute an operating system (OS) and one or more applications. The OS comprises a display controller configured to manage display content presented on one or more monitors, wherein the display content is generated from the one or more applications, and an audio output controller configured to manage audio content provided to one or more audio playback devices. The OS is configured to determine a screen location of a first application window displayed on the one or more monitors, wherein the first application window contains display content associated with a first application, determine a screen location of a second application window displayed on the one or more monitors, wherein the second application window contains display content associated with a second application, and automatically apply a modification to audio content associated with the second application when the OS determines that the screen location of the second application window is overlapped at least in part by the screen location of the first application window.

According to another aspect, the modification to the audio content associated with the second application creates a depth indication for a user to designate a source of the audio content is an application window displayed behind the first application window. According to yet another aspect, the modification to audio content associated with the second application is muffling the audio content. According to another aspect, the modification to audio content associated with the second application is distortion of the audio content. According to yet another aspect, the modification to audio content associated with the second application is one or more of: applying a low pass filter to the audio content, applying a reverb effect to the audio content, applying an echo effect to the audio content, applying a delay to the audio content, and applying a frequency-shift to the audio content.

According to another aspect, the first application window and the second application window are associated with separate tabs on a browser application, and the first and second applications are associated with different websites.

According to yet another aspect, the OS is further configured to determine a screen location of a third application window displayed on the one or more monitors, wherein the third application window contains display content associated with a third application, and automatically apply a second modification to audio content associated with the third application when the OS determines that the screen location of the third application window is overlapped at least in part by the screen location of both the first application window and the second application window.

### BRIEF DESCRIPTION OF THE DRAWINGS

Having thus described the invention in general terms, reference will now be made to the accompanying drawings, which are not necessarily drawn to scale, and wherein:

FIG. 1 is a block diagram illustrating an embodiment of an Information Handling System for use with audio spatial panning.

FIG. 2 illustrates an example embodiment of a workstation having multiple monitors that may be used to display applications that generate audio content.

FIG. 3 illustrates an example system for generating audio spatial notifications for an application window that is presented across multiple monitors or displays.

FIG. 4 illustrates an example system for generating audio spatial notifications that include a height or vertical component in addition to horizontal panning.

FIG. 5 illustrates an example system for generating audio spatial notifications that include a depth component that is separate from the X/Y positioning of application windows.

FIG. 6 illustrates an example system for generating audio spatial notifications that include a depth component associated with different browser tabs.

FIG. 7 is a block diagram illustrating components of a system for providing audio spatial notifications.

### DETAILED DESCRIPTION

The invention now will be described more fully hereinafter with reference to the accompanying drawings. This invention may, however, be embodied in many different forms and should not be construed as limited to the embodiments set forth herein. Rather, these embodiments are provided so that this disclosure will be thorough and complete, and will fully convey the scope of the invention to those skilled in the art. One skilled in the art may be able to use the various embodiments of the invention.

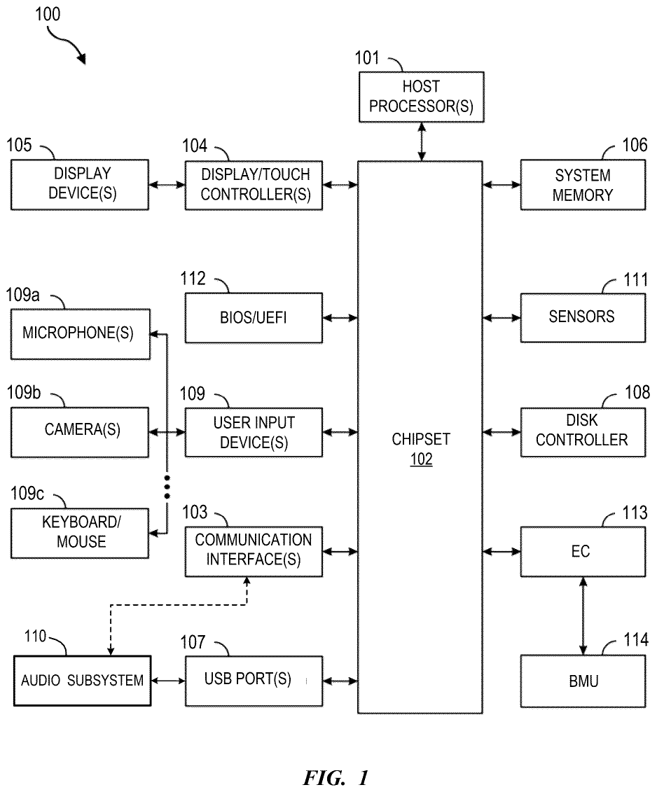

FIG. 1 is a block diagram illustrating an embodiment of an IHS 100. As depicted, IHS 100 includes host processor(s) 101. In various embodiments, IHS 100 may be a single-processor system, or a multi-processor system including two or more processors. Host processor(s) 101 may include any processor capable of executing program instructions, such as an INTEL/AMD x76 processor, or any general-purpose or embedded processor implementing any of a variety of Instruction Set Architectures (ISAs), such as a Complex Instruction Set Computer (CISC) ISA, a Reduced Instruction Set Computer (RISC) ISA (e.g., one or more ARM core(s), or the like).

IHS 100 includes chipset 102 coupled to host processor(s) 101. Chipset 102 may provide host processor(s) 101 with access to resources. In some cases, chipset 102 may utilize a QuickPath Interconnect (QPI) bus to communicate with host processor(s) 101. Chipset 102 may also be coupled to communication interface(s) 103 to enable communications between IHS 100 and various wired and/or wireless networks, such as Ethernet, WiFi (IEEE 802.11), Bluetooth® (IEEE 802.15.1), cellular or mobile networks (e.g., Code-Division Multiple Access or “CDMA,” Time-Division Multiple Access or “TDMA,” Long-Term Evolution or “LTE,” etc.), satellite networks, or the like. Communication interface(s) 103 may be used to communicate with peripheral devices (e.g., Bluetooth® speakers, microphones, headsets, etc.). Moreover, communication interface(s) 103 may be coupled to chipset 102 via a Peripheral Component Interconnect Express (PCIe) bus, or the like.

Chipset 102 may be coupled to display and/or touchscreen controller(s) 104, which may include one or more Graphics Processor Units (GPUs) on a graphics bus, such as an Accelerated Graphics Port (AGP) or PCIe bus. As shown, display controller(s) 104 provide video or display signals to one or more display device(s) 105. Display device(s) 105 may include Liquid Crystal Display (LCD), Light Emitting Diode (LED), Organic LED (OLED), or other thin film display technologies. Display device(s) 105 may include a plurality of pixels arranged in a matrix, configured to display visual information, such as text, two-dimensional images, video, three-dimensional images, etc. In some cases, display device(s) 105 may be provided as a single continuous display, rather than two discrete displays.

Chipset 102 may provide host processor(s) 101 and/or display controller(s) 104 with access to system memory 106. In various embodiments, system memory 106 may be implemented using any suitable memory technology, such as static RAM (SRAM), dynamic RAM (DRAM) or magnetic disks, or any nonvolatile/Flash-type memory, such as a Solid-State Drive (SSD), Non-Volatile Memory Express (NVMe), or the like.

In certain embodiments, chipset 102 may also provide host processor(s) 101 with access to one or more Universal Serial Bus (USB) ports/controllers 107, to which one or more peripheral devices may be coupled (e.g., integrated or external webcams, microphones, speakers, etc.).

Chipset 102 may further provide host processor(s) 101 with access to a disk controller 108, which may include a disk interface that connects the disc controller 108 to a Hard Disk Drive (HDD), an Optical Disk Drive (ODD), an SSD, and/or a disk emulator. The disk interface may include, for example, an Integrated Drive Electronics (IDE) interface, an Advanced Technology Attachment (ATA) such as a parallel ATA (PATA) interface or a serial ATA (SATA) interface, a SCSI interface, a USB interface, a proprietary interface, or a combination thereof. The disk emulator may be provide an external interface that permits one or more hard disk drives, solid-state drives, optical drives, or other removable-media drives to be connected to IHS 100. An example of external interface includes a USB interface, an IEEE 1394 (Firewire) interface, a proprietary interface, or a combination thereof.

Chipset 102 may also provide access to one or more user input devices 109, for example, using a super I/O controller or the like. Examples of user input devices 109 include, but are not limited to, microphone(s) 109a, camera(s) 109b, and/or keyboard/mouse 109c. Other user input devices 109 (not shown) may include a touchpad, stylus or active pen, totem, etc. Each user input device 109 may include a respective controller (e.g., a touchpad may have its own touchpad controller) that interfaces with chipset 102 through a wired or wireless connection, for example via communication interfaces(s) 103 and/or USB port(s) 107.

In some cases, chipset 102 may also provide access to one or more output devices, such as an audio subsystem 110, speakers, headsets, video projectors, paper printers, 3D printers, Virtual/Augmented Reality (VR/AR) devices, etc. The output devices may be accessed, for example, via communication interfaces(s) 103 and/or USB port(s) 107

In certain embodiments, chipset 102 may further provide an interface for communications with one or more hardware sensors 111. Sensors 111 may be disposed on or within the chassis of IHS 100, or otherwise coupled to IHS 100, and may include, but are not limited to: electric, magnetic, radio, optical (e.g., camera, webcam, etc.), infrared, thermal, force, pressure, acoustic (e.g., microphone), ultrasonic, proximity, position, deformation, bending, direction, movement, velocity, rotation, gyroscope, Inertial Measurement Unit (IMU), and/or acceleration sensor(s).

A Basic Input and Output System/Unified Extensible Firmware Interface (BIOS/UEFI) 112 is coupled to chipset 102. UEFI was designed as a successor to BIOS, and many modern IHSs utilize UEFI in addition to or instead of a BIOS. Accordingly, BIOS/UEFI 112 is intended to also encompass a UEFI component. BIOS/UEFI 112 provides an abstraction layer that allows the OS to interface with certain hardware components that are utilized by IHS 100. Upon booting of IHS 100, host processor(s) 101 may utilize program instructions of BIOS 112 to initialize and test hardware components coupled to IHS 100, and to load a host OS for use by IHS 100. Via the hardware abstraction layer provided by BIOS/UEFI 112, software stored in system memory 106 and executed by host processor(s) 101 can interface with I/O devices coupled to IHS 100.

An Embedded Controller (EC) 113 (sometimes referred to as a Baseboard Management Controller or “BMC”) includes a microcontroller unit or processing core dedicated to handling selected IHS operations not ordinarily handled by host processor(s) 101. Examples of such operations may include, but are not limited to: power sequencing, power management, receiving and processing signals from a keyboard or touchpad, as well as other buttons and switches (e.g., power button, laptop lid switch, etc.), receiving and processing thermal measurements (e.g., performing cooling fan control, throttling CPUs and GPUs, controlling colling fan speeds, and emergency shutdown), controlling indicator Light-Emitting Diodes (LEDs) (e.g., caps lock, scroll lock, num lock, battery, ac, power, wireless LAN, sleep, etc.), managing the battery charger and the battery, enabling remote or Out-of-Band (OOB) management, diagnostics, and remediation over network(s), and the like.

Unlike other devices in IHS 100, EC 113 may be made operational from the very start of each power reset, before other devices are fully running or powered on. As such, EC 113 may be responsible for interfacing with a power adapter to manage the power consumption of IHS 100. These operations may be utilized to determine the power status of IHS 100, such as whether IHS 100 is operating from battery power or is plugged into an AC power source. Firmware instructions utilized by EC 113 may be used to manage other core operations of IHS 100 (e.g., turbo modes, maximum operating clock frequencies of certain components, etc.).

In some cases, EC 113 may implement operations for detecting certain changes to the physical configuration or posture of IHS 100 and managing other devices in different configurations of IHS 100. For instance, when IHS 100 as a 2-in-1 laptop/tablet form factor, EC 113 may receive inputs from a lid position or hinge angle sensor 111, and it may use those inputs to determine: whether the two sides of IHS 100 have been latched together to a closed position or a tablet position, the magnitude of a hinge or lid angle, etc. In response to these changes, the EC may enable or disable certain features of IHS 100 (e.g., front or rear facing camera, etc.).

In some implementations, EC 113 may be installed as a Trusted Execution Environment (TEE) component to the motherboard of IHS 100. Additionally, or alternatively, EC 113 may be further configured to calculate hashes or signatures that uniquely identify individual components of IHS 100. In such scenarios, EC 113 may calculate a hash value based on the configuration of a hardware and/or software component coupled to IHS 100. For instance, EC 113 may calculate a hash value based on all firmware and other code or settings stored in an onboard memory of a hardware component.

In addition, EC 113 may provide an Out-of-Band communication channel that allows an Information Technology Decision Maker (ITDM) or Original Equipment Manufacturer (OEM) to manage IHS 100's various settings and configurations, for example, by issuing OOB commands.

In various embodiments, IHS 100 may be coupled to an external power source through an AC adapter, power brick, or the like. The AC adapter may be removably coupled to a battery charge controller to provide IHS 100 with a source of DC power provided by battery cells of a battery system in the form of a battery pack (e.g., a lithium ion or “Li-ion” battery pack, or a nickel metal hydride or “NiMH” battery pack including one or more rechargeable batteries). Battery Management Unit (BMU) 114 may be coupled to EC 113 and it may include, for example, an Analog Front End (AFE), storage (e.g., non-volatile memory), and a microcontroller. In some cases, BMU 114 may be configured to collect and store information, and to provide that information to other IHS components.

Examples of information collectible by BMU 114 may include, but are not limited to: operating conditions (e.g., battery operating conditions including battery state information such as battery current amplitude and/or current direction, battery voltage, battery charge cycles, battery state of charge, battery state of health, battery temperature, battery usage data such as charging and discharging data; and/or IHS operating conditions such as processor operating speed data, system power management and cooling system settings, state of “system present” pin signal), environmental or contextual information or state (e.g., such as ambient temperature, relative humidity, system geolocation measured by GPS or triangulation, time and date, etc.), events, etc. Examples of events may include, but are not limited to: acceleration or shock events, system transportation events, exposure to elevated temperature for extended time periods, high discharge current rate, combinations of battery voltage, battery current and/or battery temperature (e.g., elevated temperature event at full charge and/or high voltage causes more battery degradation than lower voltage), etc.

In some embodiments, IHS 100 may not include all the components shown in FIG. 1. Furthermore, some components that are represented as separate components in FIG. 1 may instead be integrated with other components, such that all or a portion of the operations executed by the illustrated components may instead be executed by the integrated component. For example, in various embodiments described herein, host processor(s) 101 and/or other components shown in FIG. 1 (e.g., chipset 102, display controller(s) 104, communication interface(s) 103, EC 113, etc.) may be replaced by other devices. As such, IHS 100 may assume different form factors including, but not limited to: servers, workstations, desktops, laptops, appliances, video game consoles, tablet computers, smartphones, etc.

Current systems present audio notifications without spatial differentiation with respect to where the source of the notification is located on a display. This causes application and system sounds to appear centrally without directional cues. The existing configurations hinder users from quickly identifying the source of notifications since the audio seems to emanate equally from both sides. Users face challenges in relying on audio cues for efficient notification identification and location. Existing configurations lack a method to determine which display manages audio notifications when multiple screens are in use. The absence of spatial properties in notifications limits user awareness of the origin, particularly when windows overlap or are spread across several screens. Embodiments disclosed herein provide a solution that improves user interaction by providing audio cues aligned with the screen location of notification events.

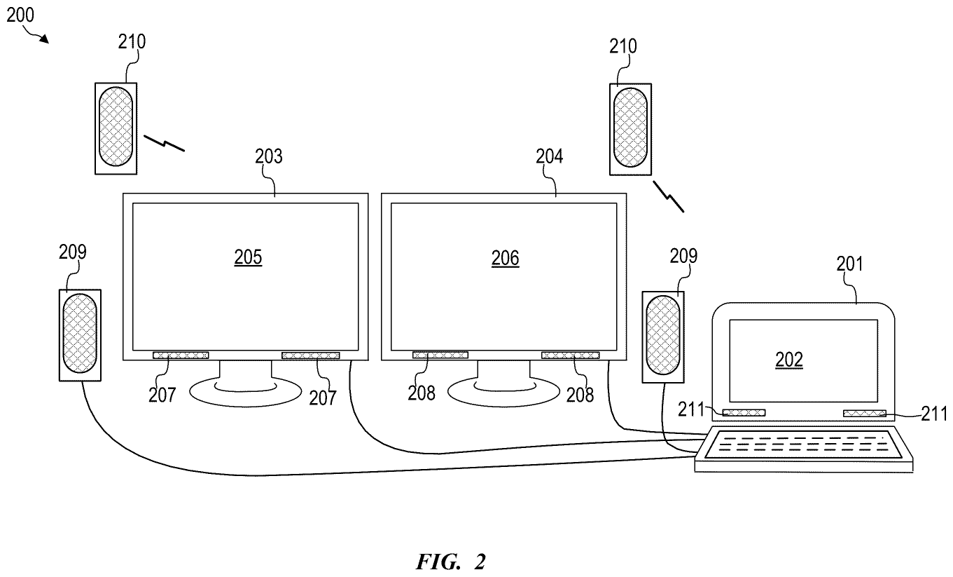

FIG. 2 illustrates an example embodiment of a workstation 200 having multiple monitors that may be used to display applications that generate audio content. An IHS 201, such as a laptop computer, has an architecture such as the embodiment shown in FIG. 1. IHS 201 may alternatively be a desktop computer, tablet computer, game console, or other device that supports multiple monitors. In the illustrated embodiment, laptop IHS 201 has a display screen 202 that is used to display applications and other content. IHS 201 is coupled to two external monitors 203, 204 having displays 205, 206, respectively. User interfaces and other visual content generated by applications running on IHS 201 may also be displayed on either or both external monitors 203, 204. Each monitor 203, 204 may have one or more speakers 207, 208, respectively. The monitors 203, 204 are connected to IHS 201 via a wired or wireless connection (e.g., HDMI cable, audio cable, Bluetooth® connection, etc.) that allows audio content from applications running on IHS 201 to be played over speakers 203 and/or 204.

IHS 201 is also connected to a first pair of external speakers 209 and a second pair of external speakers 210. Speakers 209, 210 may be connected to IHS 201 a wired or wireless connection (e.g., audio cable, Bluetooth® connection, etc.). Additionally, IHS 201 may have internal speakers 211.

Devices, such as IHS 201, using existing Operating Systems (OS), such as Windows 10, macOS, or Linux OS, determine which speakers to use based on a selected audio output device configuration. This may include a default output device wherein the OS assigns a default audio output device, such as built-in speakers, external speakers, headphones, Bluetooth devices, etc.), on which sounds are played. A user may manually select the preferred audio device in the OS sound settings. In some cases, built-in detection systems either in IHS hardware or the OS may prioritize external audio devices, such as speakers using an audio jack or a Bluetooth/USB connection. Audio drivers, such as software that interfaces between the OS and audio hardware, may also manage which speakers are used. Using currently available sound settings, IHS 201 selects only one set of speakers, 207, 208, 209, 210, or 211 to play audio content. Audio signals are routed directly to audio subsystem 110 for presentation by the selected speakers only. To use a different set of speakers in current systems, the user must select a new default speaker in the OS audio or sound settings.

In existing systems, the interface for applications running on IHS 201 may be presented on any of displays 202, 205, 206 and/or may be positioned so that they overlap multiple displays. Current OS audio management does not provide any positional properties based on application display. Instead, no matter which display is being used for an application, the sounds associated with that application will be broadcast over the selected output speaker.

The perceived location/source of sounds (such as audio created by applications or notifications generated by the OS) is based upon the selected default speakers. Generally, perceived location is in the “center” of the broadcast audio (i.e., between the selected pair of speakers). For example, if an application is displayed on monitor 203 but internal speakers 211 are selected, then any sounds generated by the application will be played over speakers 211. This will give the impression that the source of the sounds is on IHS display 202 even though the application is actually shown in a window on display 205. Therefore, in current systems, if multiple applications are presented in windows on different displays, the user cannot use audible cues to quickly find or identify the source of a notification.

In one embodiment, when a system has multiple sets of speakers (such as illustrated in FIG. 2), audio is emitted from speakers associated with the monitor that is displaying a window that created the notifications. This allows the user to more quickly find the window that is emitting notification audio. In situations where it is critical for the user to find the source of notifications, this will help provide valuable data to the user so they can quickly identify which monitor is displaying a related window. Audio spatial notifications can be broadcast to users in order to provide information regarding the screen location of notification events (i.e., location of application windows that generate audio). In various embodiments, these audio spatial notifications include not just the left-right or X/Y positioning of the source window but may also include a “depth” indicator for events that happen in application windows that are buried behind other windows.

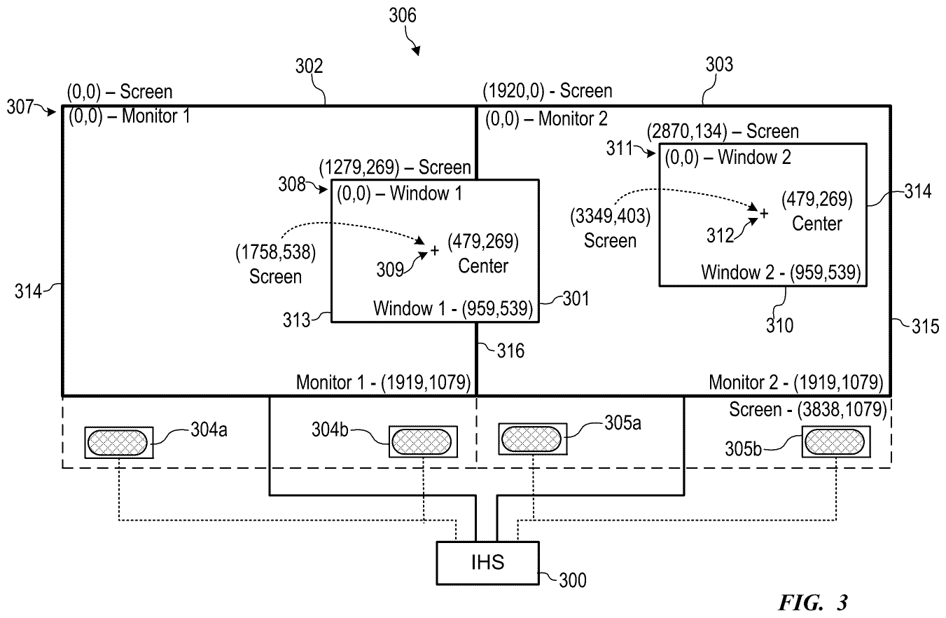

FIG. 3 illustrates an example system for generating audio spatial notifications for an application window 301 that is presented across multiple monitors or displays 302, 303. An IHS 300, such as a laptop or desktop computer, is connected to monitors 302, 303. A user of IHS 300 may position application windows, such as windows 301, 310, anywhere on displays 302, 303. The application windows 301, 310 may fully cover either or both display surfaces (i.e., maximized display view). Alternatively, the application windows may partially overlap one or both of the displays surfaces as shown for window 301 in FIG. 3. Monitors 302, 303 are connected to IHS 300, which generates the display content based upon various applications executing on the IHS. For example, IHS 300 may run productivity applications (e.g., word processing, spreadsheets, presentation software, and project management tools), web browsers, communication and collaboration tools (e.g., email clients, video conferencing, and messaging platforms), media and entertainment applications, development and coding tools, gaming applications, or other applications used in professional, personal, and entertainment contexts on laptops. These applications may generate audio content, such as user audio from a video conference, movie dialog and/or music in an entertainment application, and tones generated by OS system alerts and error/warning popups.

Each monitor 302, 303 may be associated with one or more speakers. For example, speakers 304a,b may be associated with monitor 302, such as speakers located in the housing of monitor 302. Similarly, speakers 305a,b may be associated with monitor 303. Alternatively, one or more of speakers 304a,b and 305a,b may be external speakers that are separate from monitors 302, 303 and that are connected directly to IHS 300. For example, speakers 304a and 305b may be individual external speakers that are located on opposites of monitors 302, 303.

In current systems, default speakers would be selected by an IHS to broadcast all audio associated with application window 301 without regard to which monitor(s) 302, 303 display the application window 301. The audio spatial notification system disclosed herein allows for IHS 300 to use panning to control the audio output. Panning refers to distributing a stereo or mono audio signal throughout the left and right channels of a stereo field so that the “center” of the audio can be adjusted from side to side across a horizontal space. To provide the audio spatial notifications, IHS 300 must make a determination as to which display is responsible for handling the audio notifications and the location of the application window within the displays.

In a configuration using multiple displays, the relationship between an application window and the displays is determined by IHS 300 calculating which display 302, 303 contains the most pixels of the window 301. Assuming that application windows and displays are rectangular, whichever display contains the center point of the application window should contain the most pixels for the window. Therefore, that display with the center point would be responsible for handling any audio notifications from the application window. The algorithm can establish a tie breaker by rounding down in the case of a tie. This provides a new method for mapping individual windows to the display regions. The responsible display location is then used to control the playing of audio notifications on particular speakers to increase the user's awareness of the location of the application window that originated the notification.

Monitors 302 and 303 are the same size in the example shown in FIG. 3. In other configurations, more than two displays may be used and the displays may or may not be the same size. The display surfaces on monitors 302, 303 are each 1919 pixels wide and 1079 pixels high. Taken together, monitors 302, 303 provide a total display screen 306 that is 3838 pixels wide and 1079 pixels high. For purposes of this example, the top left corner 307 of the monitors and/or total screen region is used as the screen origin for reference.

Application window 301 is 959 pixels wide and 539 pixels high in the example shown in FIG. 3. The origin 308 of window 301 (i.e., the upper left corner) is located at pixel (1279,269) relative to total display screen 306. As used herein, “(x,y)” represents the x- and y-coordinates of the referenced pixel or point within a display, screen, or window. It will be understood that a user may resize and move window 301 to cover a bigger or smaller portion of the display area 306 depending on the user's need, such as the size and position of other application windows. The center 309 of window 301 can be determined using math. The center 309 of window 301 is (479,269), which is half of (959,539) rounded down to whole number values.

By adding the center point (479,269) of application window 301 to its origin (1279,269), the location of the center point 309 of window 301 relative to screen 306 can be calculated as (1758,538). This center point 309 is located within the display region of monitor 302; therefore, speakers 304a,b associated with monitor 302 are responsible for playing any audio content generated by applications running in window 301.

Another application window 310 is also presented on screen 306. For simplification of the description herein, window 310 is the same size as window 301. However, in other embodiments, window 310 may be any size and location on screen 306. The origin point 311 for window 310 is located at (2870,134) relative to screen 306. Accordingly, the center point 312 of window 310 is (3349,403) relative to screen 306. This center point 312 is located within the display region of monitor 303; therefore, speakers 305a,b associated with monitor 303 are responsible for playing any audio content generated by applications running in window 310.

Further to the example described above in FIG. 3, if a first application is running in window 301, any audio associated with that first application will be played by speakers 304a,b on the left side of the system. This will indicate to the user that an application associated with a display window centered generally on the left side of screen 306 has generated the audio. On the other hand, if a second application is running in window 310 and generates a second audio signal, then that second audio will be played by speakers 305a,b on the right side of the system. This indicates that an application associated with a display window centered generally on the right side of screen 306 has generated the second audio. This panning of audio across the screen horizontally will assist the user to quickly identify which application has generated the audio, which may indicate that the application requires some response, input, or other interaction.

The example above uses the centers 309, 312 of application windows 301, 310 to determine in which monitor 302, 303 the windows are located. In other embodiments, other aspects of the application windows 301, 310 may be used to determine where the windows are located. For example, the origin points 308, 311 (e.g., a particular corner of the window) may be used instead of the center points 309, 312. The location of the origin point 308 or 311 can be identified as located in the display area of either monitor 302, 303 and then the window 301, 310 may be associated with that monitor for purposes of selecting which speakers should play audio generated by applications running in the window 301 or 310.

In an alternative configuration, an outside edge 313 (window 301) or 314 (window 310) of an application window may be used to determine which monitor 302, 303 should be used to select speakers associated with applications in that window. The outside edge of an application window may be determined as the edge of a window closest to an outside edge 314, 315 of the screen 306 or the edge of a window furthest from a center 316 of the screen 306. Once the outside edge of a window is identified, the location of that edge within one of monitors 302, 303 display area is used to select which speakers should play audio generated by applications running in the window 301 or 310.

In a further example embodiment, the percentage of window 301 or 310 display area within each monitor 302, 303 may be used to select which speakers should play audio generated by applications running in the window 301 or 310. For example, in FIG. 3, the area of window 301 is approximately 65% within the monitor 302 display and 35% within the monitor 303 display. Accordingly, since more of window 301 is within the monitor 302 display space, then the speakers 304a,b associated with monitor 301 will be used to play audio generated within window 301. On the other hand, the area of window 310 is 100% within monitor 303 and, therefore, speakers 305a,b associated with monitor 303 will be used to play audio generated within window 310.

The example embodiments described above pair one or more speakers 304a,b or 305a,b with each monitor 302, 303 and then the IHS 300 uses the paired speaker(s) to play audio from application windows associated with that monitor. This provides a rough left-right panning for this configuration. In another embodiment, IHS 300 may have an audio mixing capability that allows for stereo control of the speakers 304a,b or 305a,b. This would allow IHS 300 to pan audio relative to the horizontal placement of application windows 301, 310 across the available screen space 306. For example, IHS 300 may employ audio panning techniques and audio mixing to position sounds within a varied stereo sound field. By adjusting the panning control, IHS 300 can audio to the left, right, or anywhere in-between thereby simulating a spatial distribution of sounds.

Using stereo mixing, IHS 300 may use speakers 304a,b and 305a,b (or a subset of them) to simulate the source of sounds as slightly left of center for audio generated in application window 301. This will provide a more accurate indicate of the audio source compared to using only the left-hand speakers 304a,b of monitor 302. On the other hand, for audio generated by application window 310, the IHS 300 may mix the audio signals across speakers 304a,b and 305a,b (or a subset of them) to simulate the source of the sounds as being generated on the far right of the sound field, which corresponds to the displayed location of window 310.

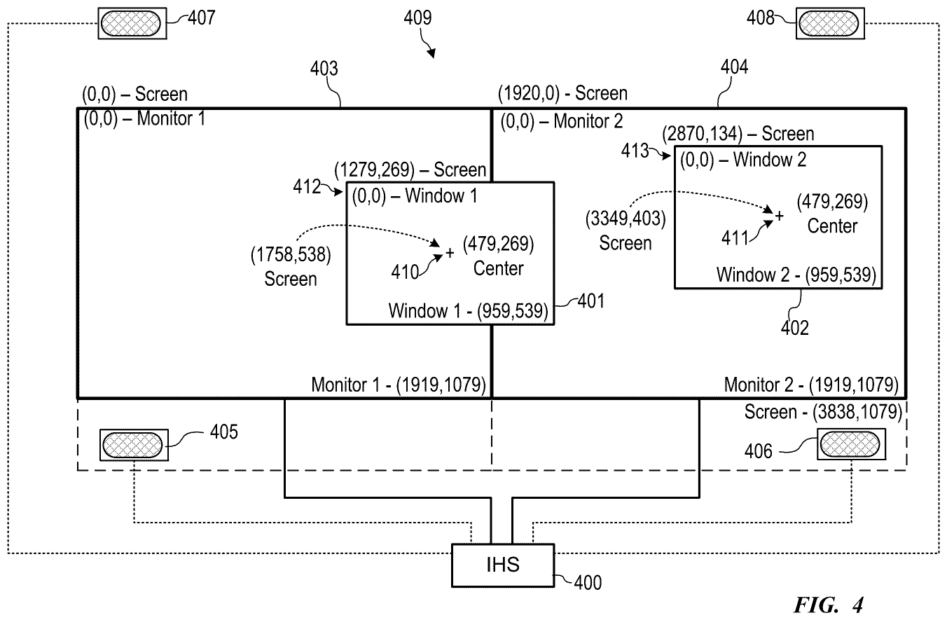

FIG. 4 illustrates an example system for generating audio spatial notifications that include a height or vertical component in addition to horizontal (i.e., left-right) panning. IHS 400 displays information, such as an application interface or system notification, in windows 401, 402 on monitors 403, 404. The user of IHS 400 may position application windows, such as windows 401, 410, anywhere on displays 402, 403.

Each monitor 403, 404 may be associated with one or more speakers. For example, speaker 405 is associated with monitor 403, and speaker 406 is associated with monitor 404. Alternatively, speakers 405, 406 may be independent of monitors 403, 404, such as external speakers that are connected directly to IHS 400. As described with respect to FIG. 3, speakers 405, 406 may be used to provide horizontal panning for audio information generated by applications shown in windows 401, 402.

FIG. 4 illustrates additional speakers 407, 408 that are also connected to IHS 400, which may use speakers 407, 408 to provide horizontal panning for audio information. Speakers 407, 408 are positioned above speakers 405, 406 and may or may not be positioned above monitors 403, 404. Because of the vertical offset between speakers 407, 408 and speakers 405, 406, IHS 400 can also mix the audio signals from applications windows 401 and 402 to simulate the source of sounds as having a vertical dimension (vertical panning) in addition to the horizontal panning discussed above.

For simplicity of description, windows 401, 402 and monitors 403, 404 have the same dimensions and locations as windows 301, 310 and monitors 302, 303 shown in FIG. 3. IHS 400 may mix the audio signals to speakers 405-408 so that the source of the sounds appear to be relatively higher or lower depending upon the location of the associated window 401 or 402. This allows IHS 400 to map the sounds in a two-dimensional or three-dimensional space rather than limiting the sounds to a particular speaker. For example, window 402 is positioned slightly higher than window 401 in the total screen display 409. Accordingly, IHS 400 will mix the audio signals sent to speakers 405-408 so that sounds generated in window 402 appear to the user to be above the sounds generated in window 401.

The vertical positioning of windows 401, 402 may be determined, for example, using the y-axis pixel location of a center point 410, 411 of the window, the origin point 412, 413 of the window, or the relative location of a top or bottom edge of the window. Alternatively, the vertical sound panning may be adjusted based upon a percentage of the window area that is above or below a midpoint of the screen 409.

While the examples shown in FIGS. 3 and 4 use two monitor displays to illustrate the location of application windows, it will be understood that these concepts can be applied to any number and configuration of monitor displays. For example, horizontal and/or vertical panning may be applied to application windows that are shown on a single monitor. Moreover, the same concepts would apply to three or more monitors arranged horizontally or to a configuration in which monitors are stacked vertically on top of each other. The IHS only needs to identify the relative horizontal and vertical positions of application windows—either to the overall screen display or to each other—and then use that relative information to mix the audio signals as appropriate to create a source sound that mimics the application window's position.

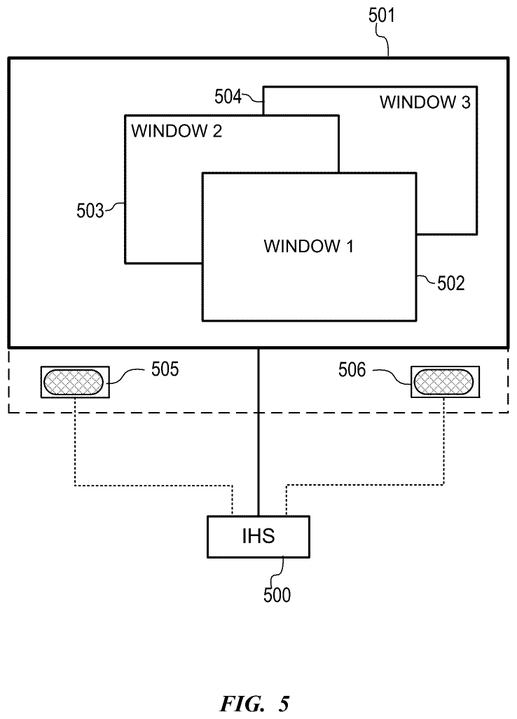

FIG. 5 illustrates an example system for generating audio spatial notifications that include a depth component that is separate from the X/Y positioning of application windows. An IHS 500 is coupled to a monitor 501 that is displaying three application windows 502-504. It is common for users to have several applications running at the same time on IHS 400 and for those to be displayed in separate application windows 502-504. The user may arrange the size and location of each application window 502-504 on monitor 501. The application currently being used is shown in window 502 while other active applications not currently being used are shown in windows 503 and 504.

The display controller for the operating system on IHS 400 will always move the window 502 for the current application in front of the other application windows 503, 504. In some cases, the active window 501 may be maximized to fit the entire display area of monitor 501. In that situation, the inactive windows 503, 504 are hidden behind the active window 502 but are still running in the background. The stacked windows shown in FIG. 5 is intended to be a screen shot of a temporary arrangement of the application windows at a particular time. A typical user will often move between different applications to read, copy, paste, or otherwise manage information among the various applications. For example, window 502 may be associated with a word processing application, window 503 may be associated with a browser application, and window 504 may be associated with an email application.

Each application runs independently and may generate alerts or sounds, such as feedback sounds from document editing, music from a webpage on a browser, and new-message alerts from an email application. As described above, IHS 500 may mix audio associated with those sounds to create horizontal and vertical panning to give the user cues regarding the location of the sound's source window. In the case of overlapping application windows 502-504, further information can be provided to the user in the form of an audio depth indicator for events that happen in a window fully or partially obscured behind other windows.

The depth indication for audio or notifications that is generated in an application window that is behind other windows may be a distortion or muffling of the sound. The distorted or muffled sound provides an aural indication to the user at IHS 500 that that the source of the sound is from a window that may not be visible to the user (e.g., sounds from a fully or partially obscured application window 503, 504 behind active window 502). This modification to the sound allows the user to more quickly find windows that are emitting notifications and other audio signals. For situations where it is critical for the user to quickly find the notification source, the depth indication provides valuable data to the user.

In the example embodiment illustrated by FIG. 5, application window 502 is in the foreground and, therefore, IHS 500 would provide normal (i.e., undistorted) audio signals to speakers 505, 506. Since the sounds are not changed by a depth indicator, the user will expect that any “normal” sounds are associated with the top level window 501. On the other hand, because window 503 is behind window 502, IHS 500 will modify any audio associated with the application shown in window 503. The modification may be, for example, a muffled sound (e.g., an audio signal modified to sound as if heard from another room or through a wall). The modifications may be introduced by altering the equalization of the audio signal, such as by applying a low pass filter to the audio signal or otherwise eliminating treble sounds and reducing mid-range sounds. Other modifications or distortions, such as introducing an echo, reverb, delay, or frequency-shift effect to the audio signal, may be used to indicate that the source of a notification is in a window that is obscured or overlapped by an active window.

For sounds that originate from an application associated with window 504, which is behind two other windows 501, 502, the modification may be applied to a greater extent (e.g., sounds from window 504 are muffled or distorted twice as much as sounds in window 503). The more layers of windows presented in front of an audio-source window may cause IHS 500 to add greater amounts of distortion.

In other configurations, IHS 500 modifies the sounds associated with obscured windows by a different effect at each layer. For example, window 502 sounds are unmodified, window 503 sounds are muffled with a low pass filter, window 504 sounds are modified with an echo effect, and sounds from the next obscured (i.e., deeper) window may be modified with a reverb effect, etc.

Other embodiments may allow the user to elect to have windows beyond a certain depth or layer to be silenced. For example, sounds from window 503 in the third layer may not be played on speakers 505, 506 since that layer has likely not been recently used. On the other hand, the sounds from windows in the top two layers at windows 501, 502 will be played with appropriate modifications since those two top windows represent the current and last-used applications.

In some cases, the user may desire to receive all of the audio associated with a window without distortion no matter how deep the window is buried behind other windows. This would apply, for example, when window 504 is associated with a music streaming service or a web/video conference application and the user wants to hear all of the related audio without modification. This would allow the user to hear music or other audio streaming in the background.

Although FIG. 5 illustrates a number of application windows 502-504 stacked on a single monitor display 501, it will be understood that the depth indication modification may also be applied to any configuration of two or more monitors that create a display screen on which application windows may overlap or obscure each other. Similarly, in addition to applying the depth indication to audio signals from a particular application window, the IHS 500 may also apply horizontal and vertical panning to the audio signals based upon the X-Y location of the application window relative to the overall display screen.

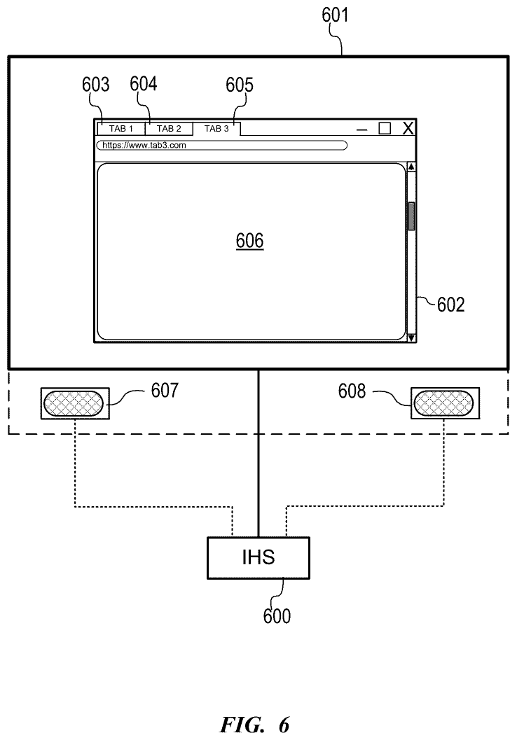

FIG. 6 illustrates an example system for generating audio spatial notifications that include a depth component associated with different browser tabs. An IHS 600 is running a browser application. IHS 600 is coupled to monitor 601 that is displaying a browser window 602. It is common for users to have multiple websites open in different browser tabs 603-605 at the same time to facilitate moving between different websites quickly. In the example browser window 602, tab 605 is currently selected and the associated webpage content is displayed in area 606. The webpages for the other browser tabs 603, 604 are not currently being displayed in browser window 602; however, the browser application running on IHS 600 may be receiving updated information from the webpages associated with tabs 603, 604.

Each webpage in tabs 603-605 may generate sounds or notifications. Similar to how IHS 500 handles audio from overlapping application windows as described with respect to FIG. 5, IHS 600 may process audio from each tab 603-605 to provide depth indicator to indicate when sounds are generated in an unselected tab.

The depth indication for audio or notifications that is generated by a webpage associated with an unselected tab may be a distorted or muffled. The distorted or muffled sound provides an aural indication to the user at IHS 600 that that the source of the sound is from a webpage on a tab that is not currently selected and/or visible to the user. This modification to the sounds generate on a hidden webpage allows the user to determine which tab has the webpage that is generating notifications and other audio signals.

In the example embodiment illustrated by FIG. 6, tab 605 is selected and, therefore, IHS 600 provides normal (i.e., undistorted) audio signals to speakers 607, 608 for any sounds or notifications generated by the webpage associated with tab 3. Since these sounds are not changed by a depth indicator, the user will expect that any “normal” sounds are associated with the top level tab 605.

On the other hand, because tabs 603 and 604 are not selected, IHS 600 will modify any audio generated from the webpages associated with those tabs. The modification may be, for example, a muffled or distorted sound. As discussed with respect to FIG. 5, the audio modifications may be introduced by altering the equalization of the audio signal, such as by applying a low pass filter to the audio signal or otherwise eliminating treble sounds and reducing mid-range sounds. Other modifications or distortions, such as introducing an echo, reverb, delay, or frequency-shift effect to the audio signal, may be used to indicate that the source of a notification is a webpage associated with an unselected tab.

The sounds originating from unselected tabs may all receive the same modification or distortion. Alternatively, the modification to the sounds on the unselected tabs may be different for each unselected tab 603, 604. For example, unselected tab 604 may be subject to more or less modification or distortion than unselected tab 603. In other configurations, each unselected tab may be assigned a different audio effect, such as muffling tab 603 sounds with a low pass filter, modifying tab 604 sounds with an echo effect, and obscuring audio from other unselected tabs with a reverb effect, etc.

In some cases, the user may desire to receive all of the audio associated with an unselected tab without distortion no matter which other tab is selected. This would apply, for example, when a tab 603 is associated with a music streaming service or a web/video conference application and the user wants to hear all of the related audio without modification. This would allow the user to hear music or other audio streaming in the background while other webpage content in a selected tab 605 are being displayed 606.

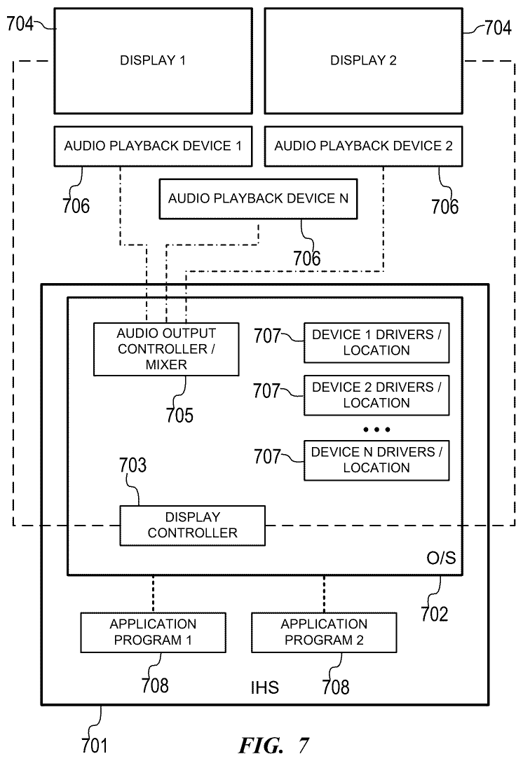

FIG. 7 is a block diagram illustrating components of a system for providing audio spatial notifications. IHS 701 has an operating system (OS) 702. A display controller module 703 in OS 702 is responsible for managing display content for one or more displays 704. An audio output controller/mixer 705 in OS 702 is responsible for managing audio content to be played on one or more audio playback device 706. Each of the audio playback devices 706 may be associated with a particular display 704 or may be an independent device, such as an external speaker, soundbar, headphones, etc.

The OS 702 maintains information regarding audio device drivers and location 707, which is associated with each of the audio playback devices 706. The audio device drivers and location 707 information may include, for example, the identity of a driver that should be loaded to use a particular audio playback devices 706 and/or the relative location of the audio playback devices 706. The location may identify a relative location of each audio playback device 706 compared to one or more of the displays 704. This may include, for example, whether the audio playback device 706 is co-located with (e.g., a component of) a particular display 706 and/or whether the audio playback device 706 is positioned left/right/above/below a particular display 706.

IHS 701 executes one or more application programs 708, such as productivity applications (e.g., word processing, spreadsheets, presentation software, and project management tools), web browsers, communication and collaboration tools (e.g., email clients, video conferencing, and messaging platforms), media and entertainment applications, development and coding tools, gaming applications, or other personal or professional applications. The application programs 708 generate display and audio content to be presented to users. The application programs 708 coordinate with OS 702 to provide the display and audio content to displays 704 and audio playback devices 706.

Using the device driver and location information 707, the audio output controller/mixer 705 is capable of controlling multiple audio playback devices at the same time—unlike current systems in which the OS only controls one audio playback device at a time. Additionally, OS 702 is aware of how the display content for a particular application program is displayed (i.e., screen location and size) on displays 704. Using the location of the display content, audio output controller/mixer 705 can manage the associated audio content and provide audio modifications so that each audio signal can be presented with horizontal (left/right), vertical (high/low), and depth (layers of windows or tabs) panning.

In an example configuration, an Information Handling System (IHS) for providing audio spatial notifications comprises at least one processor configured to execute an operating system (OS) and one or more applications. The OS comprises a display controller configured to manage display content presented across multiple monitors, wherein the display content is generated from the one or more applications; and an audio output controller configured to manage audio content provided to one or more audio playback devices. The OS is configured to determine a screen location of a first application window displayed on one or more of the multiple monitors, wherein the first application window contains display content associated with a first application; and automatically apply panning to audio content associated with the first application based upon the screen location of the first application window.

The OS may be further configured to determine a primary monitor associated with the first application window based upon the screen location; and apply the panning so that the audio associated with the first application is played by an audio playback device associated with the primary monitor.

The screen location of the first application window may be determined based upon a center point of the first application window.

The screen location of the first application window may be determined based upon an origin point of the first application window.

The screen location of the first application window may be determined based upon an edge of the first application window.

The primary monitor may be determined based upon which of the multiple monitors is displaying the highest percentage of the display content associated with the first application.

The panning may comprise horizontal panning that creates an audible indication of a horizontal location of the first application window across the multiple monitors. The horizontal panning may comprise playing audio content associated with the first application on an audio playback device associated with a primary monitor displaying the first application window. The horizontal panning may comprise applying stereo panning to audio content sent to the audio playback devices from the first application.

The panning may comprise vertical panning that creates an audible indication of a vertical location of the first application window across the multiple monitors.

The panning may comprise vertical panning that creates an audible indication of a horizontal and vertical location of the first application window across the multiple monitors.

In another example configuration, an Information Handling System (IHS) for providing audio spatial notifications comprises at least one processor configured to execute an operating system (OS) and one or more applications. The OS comprises a display controller configured to manage display content presented on one or more monitors, wherein the display content is generated from the one or more applications; and an audio output controller configured to manage audio content provided to one or more audio playback devices. The OS is configured to determine a screen location of a first application window displayed on the one or more monitors, wherein the first application window contains display content associated with a first application; determine a screen location of a second application window displayed on the one or more monitors, wherein the second application window contains display content associated with a second application; and automatically apply a modification to audio content associated with the second application when the OS determines that the screen location of the second application window is overlapped at least in part by the screen location of the first application window.

The modification to the audio content may be associated with the second application creates a depth indication for a user to designate a source of the audio content is an application window displayed behind the first application window.

The modification to audio content may be associated with the second application is muffling the audio content. The modification to audio content may be associated with the second application is distortion of the audio content.

The modification to audio content may be associated with the second application is one or more of: applying a low pass filter to the audio content, applying a reverb effect to the audio content, applying an echo effect to the audio content, applying a delay to the audio content, and applying a frequency-shift to the audio content.

The first application window and the second application window may be associated with separate tabs on a browser application, and wherein the first and second applications are associated with different websites.

The OS may be further configured to determine a screen location of a third application window displayed on the one or more monitors, wherein the third application window contains display content associated with a third application; and automatically apply a second modification to audio content associated with the third application when the OS determines that the screen location of the third application window is overlapped at least in part by the screen location of both the first application window and the second application window.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated that the conception and specific embodiment disclosed may be readily utilized as a basis for modifying or designing other structures for carrying out the same purposes of the present invention. It should also be realized that such equivalent constructions do not depart from the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

What is claimed is:

1. An Information Handling System (IHS) for providing audio spatial notifications, comprising:
at least one processor configured to execute an operating system (OS) and one or more applications, the OS comprising:
a display controller configured to manage display content presented across multiple monitors, wherein the display content is generated from the one or more applications; and
an audio output controller configured to manage audio content provided to one or more audio playback devices;
wherein the OS is configured to:
determine a screen location of a first application window displayed on one or more of the multiple monitors, wherein the first application window contains display content associated with a first application; and
automatically apply panning to audio content associated with the first application based upon the screen location of the first application window.

2. The IHS of claim 1, wherein the OS is further configured to:
determine a primary monitor associated with the first application window based upon the screen location; and
apply the panning so that the audio associated with the first application is played by an audio playback device associated with the primary monitor.

3. The IHS of claim 1, wherein the screen location of the first application window is determined based upon a center point of the first application window.

4. The IHS of claim 1, wherein the screen location of the first application window is determined based upon an origin point of the first application window.

5. The IHS of claim 1, wherein the screen location of the first application window is determined based upon an edge of the first application window.

6. The IHS of claim 2, wherein the primary monitor is determined based upon which of the multiple monitors is displaying the highest percentage of the display content associated with the first application.

7. The IHS of claim 1, wherein the panning comprises:
horizontal panning that creates an audible indication of a horizontal location of the first application window across the multiple monitors.

8. The IHS of claim 7, wherein the horizontal panning comprises playing audio content associated with the first application on an audio playback device associated with a primary monitor displaying the first application window.

9. The IHS of claim 7, wherein the horizontal panning comprises applying stereo panning to audio content sent to the audio playback devices from the first application.

10. The IHS of claim 1, wherein the panning comprises:
vertical panning that creates an audible indication of a vertical location of the first application window across the multiple monitors.

11. The IHS of claim 1, wherein the panning comprises:
vertical panning that creates an audible indication of a vertical and horizontal location of the first application window across the multiple monitors.

12. An Information Handling System (IHS) for providing audio spatial notifications, comprising:
at least one processor configured to execute an operating system (OS) and one or more applications, the OS comprising:
a display controller configured to manage display content presented on one or more monitors, wherein the display content is generated from the one or more applications; and
an audio output controller configured to manage audio content provided to one or more audio playback devices;
wherein the OS is configured to:
determine a screen location of a first application window displayed on the one or more monitors, wherein the first application window contains display content associated with a first application;
determine a screen location of a second application window displayed on the one or more monitors, wherein the second application window contains display content associated with a second application; and
automatically apply a modification to audio content associated with the second application when the OS determines that the screen location of the second application window is overlapped at least in part by the screen location of the first application window.

13. The IHS of claim 12, wherein the modification to the audio content associated with the second application creates a depth indication for a user to designate a source of the audio content is an application window displayed behind the first application window.

14. The IHS of claim 12, wherein the modification to audio content associated with the second application is muffling the audio content.

15. The IHS of claim 12, wherein the modification to audio content associated with the second application is distortion of the audio content.

16. The IHS of claim 12, wherein the modification to audio content associated with the second application is one or more of: applying a low pass filter to the audio content, applying a reverb effect to the audio content, applying an echo effect to the audio content, applying a delay to the audio content, and applying a frequency-shift to the audio content.

17. The IHS of claim 12, wherein the first application window and the second application window are associated with separate tabs on a browser application, and wherein the first and second applications are associated with different websites.

18. The IHS of claim 12, wherein the OS is further configured to:
determine a screen location of a third application window displayed on the one or more monitors, wherein the third application window contains display content associated with a third application; and
automatically apply a second modification to audio content associated with the third application when the OS determines that the screen location of the third application window is overlapped at least in part by the screen location of both the first application window and the second application window.
